(19) United States
(12) Patent Application Publication
(10) Pub. No.: US 2017/0041579 A1
(43) Pub. Date: Feb. 9, 2017

(54) PROJECTION SYSTEM, PROJECITON APPARATUS AND PROJECITON METHOD OF PROJECTION SYSTEM

(71) Applicant: Coretronic Corporation, Hsin-Chu (TW)

(72) Inventors: Wei-Mao Hung, Hsin-Chu (TW); Chih-Chen Chen, Hsin-Chu (TW); Kuei-Chin Lai, Hsin-Chu (TW)

(21) Appl. No.: 15/176,155

(22) Filed: Jun. 8, 2016

(30) Foreign Application Priority Data
Aug. 3, 2015 (CN) 201510479422.6

(51) Int. Cl. H04N 9/31; G06K 9/18; G06K 9/62

(52) U.S. Cl. CPC H04N 9/3185; G06K 9/6201; G06K 9/18

(57) ABSTRACT

A projection system, a projection apparatus and a projection method of the projection system are provided. The projection apparatus of the projection system projects an image according to image data, and captures subtitle information included in the image data. A projection unit of the projection apparatus projects the image. A control unit of the projection unit is coupled to the projection unit for capturing subtitle information. A communication unit of the projection apparatus is coupled to the control unit. A network device of the projection system stores subtitle comparison information. The communication unit communicates with the network device, and is controlled by the control unit to transmit the subtitle information to the network device. The network device compares the subtitle information with the subtitle comparison information to acquire video information corresponding to the image data.

### CROSS-REFERENCE TO RELATED APPLICATION

This application claims the priority benefit of China application Ser. No. 201510479422.6, filed on Aug. 3, 2015. The entirety of the above-mentioned patent application is hereby incorporated by reference herein and made a part of this specification.

### BACKGROUND OF THE INVENTION

Field of the Invention

The invention relates to a display apparatus, and particularly relates to a projection system and a projection method thereof.

Description of Related Art

The projector has to be connected to other hardware device such as a computer, a fixed signal source (for example, a DVD player), etc., to acquire image data such as a video, a picture, a briefing, etc., to implement the projection, and unless the user performs a control operation to the projector, the projector does not actively adjust parameters and projection content of a projected image.

Moreover, along with development of mobile devices, wireless communication and cloud networks, the amount of information needed by people in their daily life becomes larger and larger, and mobile devices have become standard equipment carried by modern people. Therefore, it is an important issue to connect the cloud network and the projector through the mobile device and the wireless communication to obtain information required by the user to develop various smart and convenient applications, so as to feed back the user with a better usage experience.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention ware acknowledged by a person of ordinary skill in the art.

### SUMMARY OF THE INVENTION

The invention is directed to a projection system, a projection apparatus and a projection method of the projection system, by which the projection apparatus is able to actively adjust parameters of a projected image to improve a viewing quality and usage convenience of the projection system, and provide the user with an interactive audio-visual experience.

Other objects and advantages of the invention can be further illustrated by the technical features broadly embodied and described as follows.

In order to achieve one or a portion of or all of the objects or other objects, an embodiment of the invention provides a projection system including a projection apparatus and a network device. The projection apparatus projects an image according to image data, and captures subtitle information included in the image data. The projection apparatus includes a projection unit, a control unit and a communication unit. The projection unit projects the image. The control unit is coupled to the projection unit and captures the subtitle information. The communication unit is coupled to the control unit. Moreover, the network device stores subtitle comparison information, the communication unit communicates with the network device, and the communication unit is controlled by the control unit to transmit the subtitle information to the network device. The network device compares the subtitle information with the subtitle comparison information to acquire video information corresponding to the image data.

The invention provides a projection apparatus adapted to communicate with a network device, and the projection apparatus includes a projection unit, a control unit and a communication unit. The projection unit projects an image according to image data. The control unit is coupled to the projection unit and captures subtitle information included in the image data. The communication unit is coupled to the control unit and communicates with the network device. The communication unit is controlled by the control unit to transmit the subtitle information to the network device, and receives video information acquired by the network device according to the subtitle information.

The invention provides a projection method of a projection system, which includes following steps. A projection apparatus is provided to project an image according to image data. Subtitle information included in the image data is captured by using the projection apparatus. The subtitle information is transmitted to a network device by using the projection apparatus. The subtitle information is compared with subtitle comparison information stored in the network device by using the network device, so as to acquire video information corresponding to the image data.

According to the above descriptions, the projection apparatus is used for capturing the subtitle information included in the image data. The network device compares the subtitle information with the subtitle comparison information to acquire the video information corresponding to the image data, such that the projection apparatus may actively adjust the parameters of the projected image according to the video information, so as to improve a viewing quality and usage convenience of the projection system. In an embodiment of the invention, the user may receive the video information through a mobile device, so as to view the video information through the mobile device or further inquire another video information related to the image. In this way, the user may experience an interactive audio-visual enjoyment.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection system according to an embodiment of the invention.

FIG. 2 is a schematic diagram of a projection system according to another embodiment of the invention.

FIGS. 3A-3B, 4A-4D, 5A-5C are flowcharts respectively illustrating a projection method of a projection system according to embodiments of the invention.

### DESCRIPTION OF EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

FIG. 1 is a schematic diagram of a projection system according to an embodiment of the invention. Referring to FIG. 1, the projection system 100 includes a projection apparatus 102 and a network device 104, the projection apparatus 102 may project an image according to image data, and then capture subtitle information Sub1 included in the image data. Further, the projection apparatus 102 may include a projection unit 106, a control unit 108 and a communication unit 110, where the control unit 108 is coupled to the projection unit 106 and the communication unit 110. The control unit 108 may control the projection unit 102 to project the image according to the image data, and may capture the subtitle information Sub1 in the image data, and transmit the subtitle information Sub1 to the network device 104 through the communication unit 110. In the embodiment, the network device 104 may store subtitle comparison information, and compare the subtitle information Sub1 coming from the projection apparatus 102 with the subtitle comparison information stored in the network device 104, so as to find video information Inf1 corresponding to the subtitle information Sub1, and accordingly acquire the video information Inf1 corresponding to the image data.

In the embodiment, the control unit 108 is, for example, a controller, a micro-controller unit, a central processing unit (CPU), a micro processor, a digital signal processor (DSP), a programmable controller, an application specific integrated circuits (ASIC), a programmable logic device (PLD), processing software or control software, though the invention is not limited to the aforementioned hardware or software. In the embodiment, the communication unit 110 can be a device, a protocol or a program/software used for implementing communication. In the embodiment, the projection unit 106 is, for example, a projection lens.

In the embodiment, the network device 104 is, for example, a cloud server, though the invention is not limited thereto, and the network device can be any electronic apparatus capable of storing the subtitle comparison information and comparing the subtitle information Sub1, with the subtitle comparison information. In other embodiments, if the subtitle comparison information stored in the network device 104 is not complied with the subtitle information Sub1, the network device 104 may also search/inquire the related subtitle comparison information required in subsequent comparison through the Internet, so as to obtain the video information Inf1 corresponding to the image data. In an embodiment, the subtitle comparison information acquired through searching/inquiring and/or the film information Inf1 can also be stored in the network device 104 for later comparison.

According to the above description, by comparing the subtitle information Sub1 with the subtitle comparison information stored in the network device 104, effectively and quick identification is implement, so as to acquire the video information Inf1 corresponding to the image data. In the embodiment, the video information Inf1 is, for example, a video type (for example, a horror movie, an action movie or a science fiction movie, etc.), an attribute, performance personnel, a video outline, a shooting location, a release/produced date, or other works of the performance personnel, etc., of the image data.

In the embodiment, after the video information Inf1 of the image data is acquired, the network device 104 may transmit the video information Inf1 to the projection apparatus 102. After the control unit 108 receives the video information Inf1 through the communication unit 110, the control unit 108 may adjust an image parameter of the image according to the video type (or the video type and image playing content) of the image data. The image parameter of the image may include a visual parameter and/or an audio parameter for presenting an audio-visual effect corresponding to the image, so as to provide the user with an audio-visual experience different to the previous experiences. For example, when the image data according to which the projection apparatus 102 projects the image is a horror movie, the control unit 108 may adjust a hue of the image to a cooler hue to increase a thriller atmosphere, such that the viewers may have an immersive experience. However, the image parameter adjustment of the image performed by the control unit 108 is not limited to the aforementioned hue adjustment, and in other embodiments, the image parameter can also be a video-audio parameter such as a brightness, a contrast, a color saturation, a sound volume, a background music, a special sound effect, etc.

Further, the subtitle information Sub1 included in the aforementioned image data is, for example, a subtitle file, which is, for example, a plain text file with an extension name of “.TXT”, though a file format thereof is not limited thereto. In the embodiment, the network device 104 may directly compare to obtain the video information Inf1 corresponding to the subtitle information Sub1 according to the plain text file with the subtitle comparison information (which can also be a plain text file, though the invention is not limited thereto), so as to acquire the video information Inf1 corresponding to the image data.

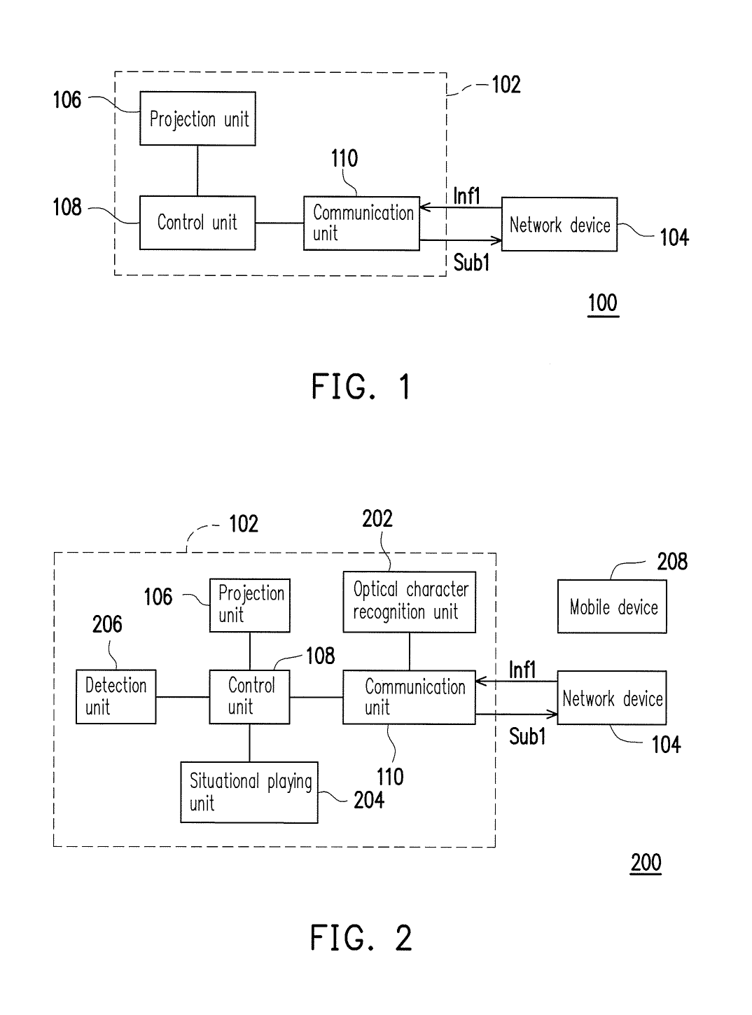

FIG. 2 is a schematic diagram of a projection system according to another embodiment of the invention. Referring to FIG. 2, a main difference between the projection system 200 of the embodiment and the projection system 100 is that the projection apparatus 102 of the projection system 200 may further include an optical character recognition (OCR) unit 202, a situational playing unit 204, a detection unit 206 and a mobile device 208. In the embodiment, the OCR unit 202 is coupled to the communication unit 110, the situational playing unit 204 and the detection unit 206 are coupled to the control unit 108. In some of the embodiments, the subtitle information Sub1 of the image data is not the plain text file, but is embedded in the image. Namely, the subtitle information Sub1 is a subtitle formed by an image, i.e. a subtitle image, and in this case, the OCR unit 202 can be used to capture and recognize the subtitle information Sub1 consisting of the subtitle image, for example, the subtitle image can be converted into subtitle text data (for example, the aforementioned plain text file with the extension name of “.TXT”, though the file format thereof is not limited thereto). In this way, the control unit 108 may transmit the subtitle text data (i.e. the subtitle information Sub1 converted from the subtitle image) to the network device 104 through the communication unit 110, and the network device 104 may quickly compare to obtain the video information Inf1 corresponding to the subtitle information Sub1, so as to acquire the video information Inf1 corresponding to the image data. Moreover, in other embodiments, the OCR unit 202 can also be directly connected to the control unit 108, and the communication unit 110 receives a recognition result from the OCR unit 202 through the control unit 108, so as to transmit the subtitle information Sub1 converted from the subtitle image to the network device 104. In the embodiment, the OCR unit 202 may have an image capturing device used for receiving an optical signal corresponding to the subtitle information Sub1 consisting of the subtitle image and have optical character recognition hardware/software used for converting the optical signal into an electric signal, so as to obtain the recognition result for outputting to the communication unit 110 or the control unit 108.

Moreover, in the embodiment, besides that the control unit 108 may adjust the image parameter (for example, the visual parameter and/or audio parameter) of the image according to the video information Inf1, the control unit 108 may also control the situational playing unit 204 according to the video information Inf1, so as to provide a situational effect corresponding to the video information Inf1. For example, the situational playing unit 204 is, for example, a plurality of light-emitting diode (LED) lamps capable of emitting different color lights, and the image data according to which the projection apparatus 102 projects the image is a horror movie, the control unit 108 may control the LED lamps to emit a green light according to the video information Inf1, or even emit alternately flashed green and blue lights and a sudden sound effect to increase the thriller atmosphere. In other embodiments, the situational playing unit 204 may further include devices used for outputting color beams and/or sounds such as an illumination system, a sound system, a loudspeaker, an imaging system, a computer system, a mobile phone, a multimedia player, etc., though the invention is not limited thereto.

Moreover, the detection unit 206 of the embodiment can be a camera, a color sensor, a sound sensor, a temperature sensor or an electronic label (for example, a RFID) reader, etc., though the invention is not limited thereto. The detection unit 206 of the embodiment may perform an environment detection according to a position where the projection apparatus 102 is located. For example, the detection unit 206 captures an image of the environment where the projection apparatus 102 is located through the camera, or uses the electronic label reader to read an electronic label to learn the environment where the projection apparatus 102 is located. The control unit 108 of the embodiment may adjust the image parameter of the image according to a detection result of the detection unit 206, and control the situational playing unit 204 to play a situational signal (for example, the LED lamp). For example, if the environment where the projection apparatus 102 is located is a conference room, when the user uses the projection apparatus 102 to the play image data in the conference room, the user probably intends to carry on related discussion other than purely viewing a video. In this case, it is unnecessary to emphasize on a video-audio playing effect, and now the control unit 108 may adjust the image parameter of the image according to the environment of the conference room, and control the situational effect provided by the situational playing unit 204, for example, to decrease an amplitude of the image parameter adjustment and decrease the situational effect of the situational playing unit 204, or even not to adjust the image parameter, for example, the control unit 108 disables the situational playing unit 204 to avoid adjusting the image parameter, though the invention is not limited thereto.

Moreover, in the embodiment, the mobile device 208 can be used for communicating with the projection apparatus 102 and/or the network device 104, where the mobile device 208 is, for example, a portable telephone, a smart phone, a notebook computer or a tablet computer, though the invention is not limited thereto. After the network device 104 of the embodiment acquires the video information Inf1 corresponding to the image data, the network device 104 may transmit the video information Inf1 to the mobile device 208, and the mobile device 208 may display according to the video information Inf1, for example, the mobile device 208 displays video related information such as a video type, an attribute, performance personnel, a video outline, a shooting location, a release/produced date, etc., to facilitate the user viewing related video data/information through the mobile device 208 while watching the video. Moreover, if the user is interested in the related video data/information and wants to further inquire another video information related to the video data/information, for example, wants to inquire other video related to the performance personnel, the user may use the mobile device 208 to send an inquiry request to the projection apparatus 102, and the control unit 108 may receive the inquiry request through the communication unit 110, and transmit the inquiry request to the network device 104 through the communication unit 110, so as to request the network device 104 to respond/answer the inquired video information related to the performance personnel. Moreover, if the user is not satisfied with a result the image parameter of the image adjusted by the projection apparatus 102 according to the video information, the user may use the mobile device 208 to send an image parameter adjustment instruction to the projection apparatus 102, so as to control the projection apparatus 102 to adjust the image parameter of the image to a desired setting of the user. Moreover, if the user is interested in an article (for example, a piece of clothing or a car, etc.) appeared in the video during the process of viewing the video, the user may also use the mobile device 208 to send an inquiry request to the network device 104 to inquire, for example, a clothing brand or a car price, etc. The network device 104 may respond/answer another video information corresponding to the image data to the mobile device 102 according to the video related information stored therein, i.e. respond/answer the inquiry request of the user, for example, to transmit the information of the clothing brand or the car price to the mobile device 102. In other embodiments, if the network device 104 does not store the data for responding/answering the inquiry request, the network device 104 may also actively search related information through a network searching engine, and transmit a searching result to the mobile device 102 to ensure the user to get the related information. In this way, the user may experience an interactive audio-visual enjoyment.

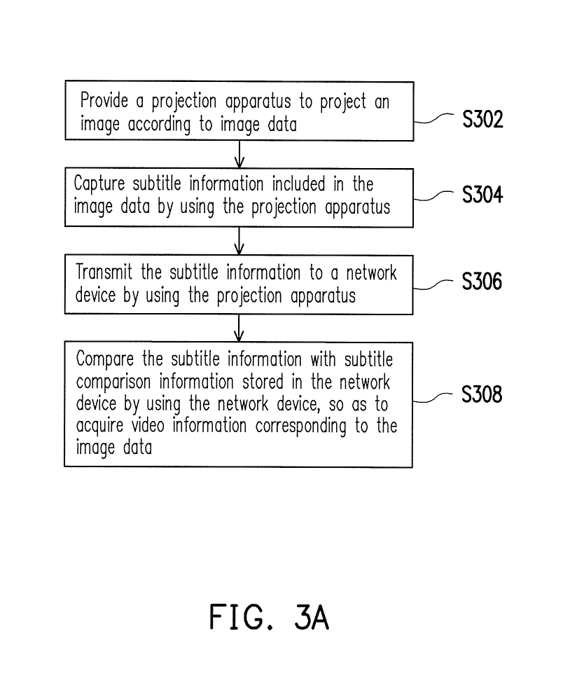

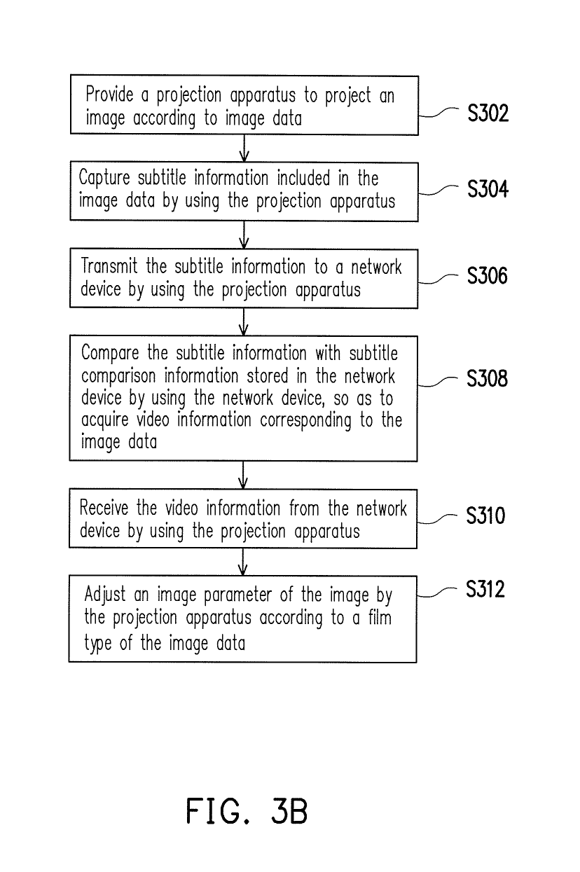

FIG. 3A is a flowchart illustrating a projection method of a projection system according to an embodiment of the invention. Referring to FIG. 3A, according to the aforementioned embodiment, it is known that the projection method of the projection system may include following steps. First, a projection apparatus is provided to project an image according to image data (step S302). Then, a subtitle information included in the image data is captured by using the projection apparatus (step S304), where the subtitle information is, for example, a subtitle file (for example, a plain text file with an extension name of “.TXT”), or a subtitle image embedded in the image. If the subtitle information is the subtitle image embedded in the image, the projection apparatus can be used to capture and recognize the subtitle image to obtain the subtitle information. Then, the subtitle information is transmitted to a network device by using the projection apparatus (step S306). The subtitle information is compared with subtitle comparison information stored in the network device by using the network device, so as to acquire video information corresponding to the image data (step S308).

FIG. 3B is a flowchart illustrating a projection method of a projection system according to another embodiment of the invention. Referring to FIG. 3B, the steps S302, S304, S306 and S308 may refer to related descriptions of the embodiment of FIG. 3A, and details thereof are not repeated. In the embodiment, after the step S308, the video information is received from the network device by using the projection apparatus (step S310), such that the projection apparatus adjusts an image parameter of the image according to a video type of the image data (step S312), where the video information includes the video type, an attribute, performance personnel, a video outline, a shooting location, a release/produced date, etc., of the image data.

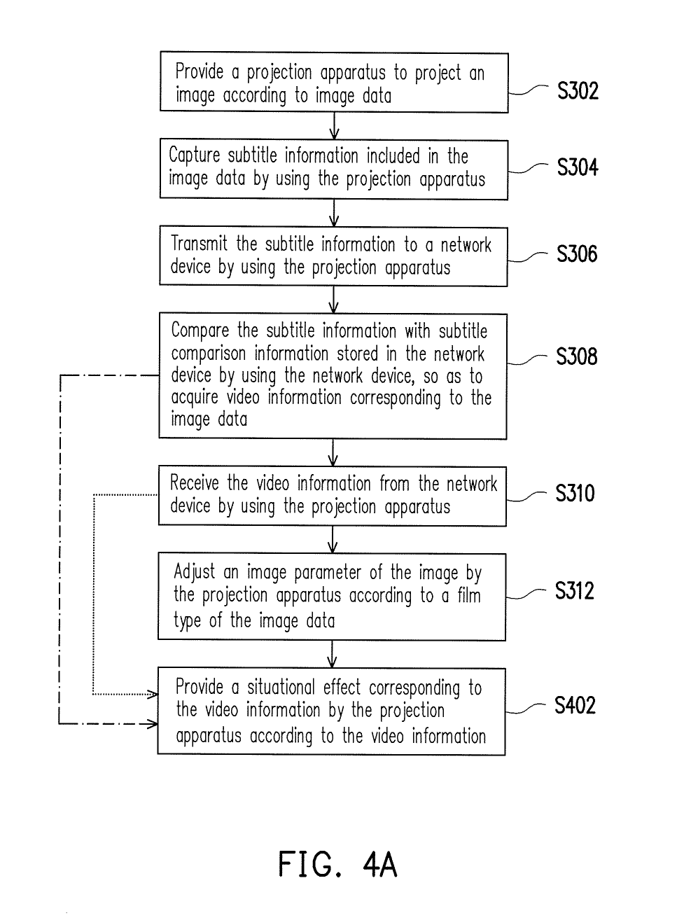

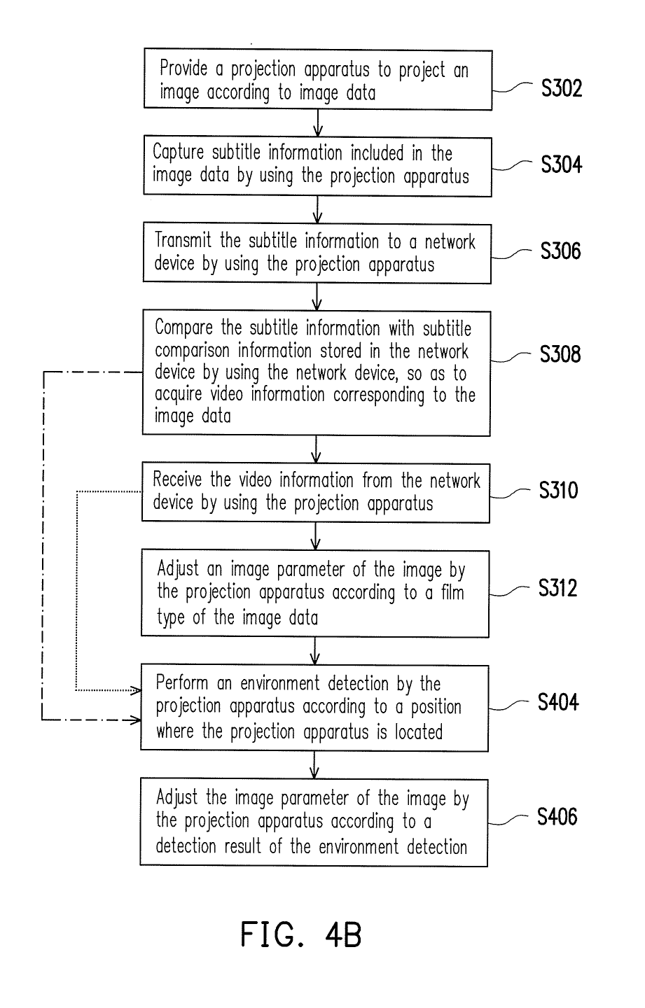

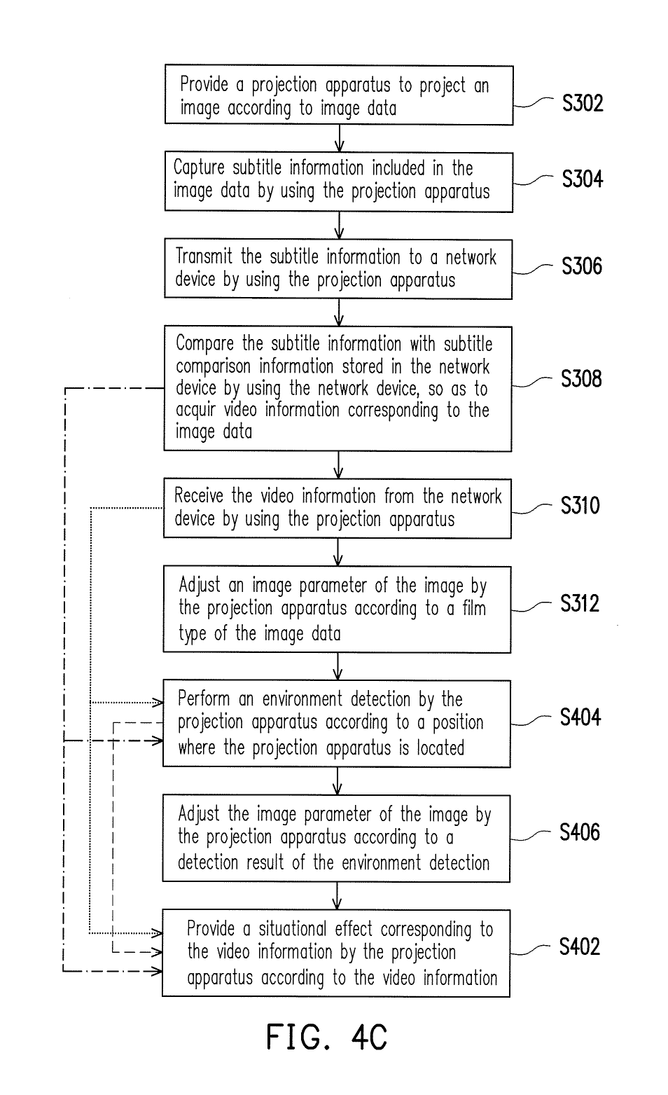

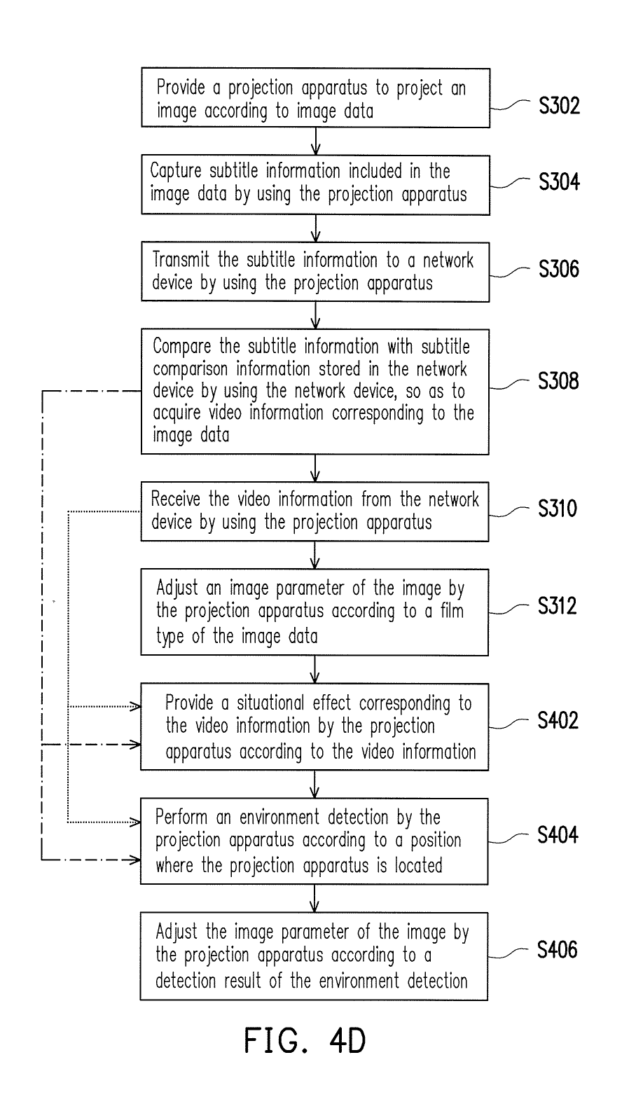

FIG. 4A is a flowchart illustrating a projection method of a projection system according to another embodiment of the invention. Referring to FIG. 4A, in the embodiment, the projection method of the projection system may further include a step S402 after the step S312, i.e. the projection apparatus provides a situational effect corresponding to the video information according to the video information (step S402). Moreover, in other embodiments, the step S402 can be executed after the step S308 or the step S310, i.e. after the video information corresponding to the image data is acquired or after the video information is received form the network device through the projection apparatus, the projection apparatus may accordingly provide the situational effect corresponding to the video information according to the video information.

FIG. 4B is a flowchart illustrating a projection method of a projection system according to another embodiment of the invention. Referring to FIG. 4B, in the embodiment, after the step S312, the projection method of the projection system further includes a step S404 and a step S406. To be specific, in the step S404, the projection apparatus performs an environment detection according to a position where the projection apparatus is located, and then in the step S406, the projection apparatus again adjusts the image parameter of the image according to a detection result of the environment detection. Moreover, in other embodiments, the step S404 can be executed after the step S308 or the step S310, i.e. after the video information corresponding to the image data is acquired or after the video information is received form the network device through the projection apparatus, the projection apparatus may accordingly perform the environment detection according to the position where the projection apparatus is located.

FIG. 4C is a flowchart illustrating a projection method of a projection system according to another embodiment of the invention. Referring to FIG. 4C, a main difference between the projection method of the projection system of the embodiment and the projection method of FIG. 4B is that after the step S406, the step S402 can be executed, i.e. after the projection apparatus adjusts the image parameter of the image according to the detection result of the environment detection, the projection apparatus again provides the situational effect corresponding to the video information according to the video information. Moreover, in other embodiments, the steps S404 and S402 can be simultaneously/sequentially executed after the step S308. In some embodiments, the steps S404 and S402 can be simultaneously/sequentially executed after the step S310. Moreover, in an embodiment, after the step S404, the steps S406 and S402 can be simultaneously executed, i.e. after performing the environment detection according to the position where the projection apparatus is located, the projection apparatus simultaneously executes the step of adjusting the image parameter of the image according to the detection result of the environment detection and the step of providing the situational effect corresponding to the video information according to the video information.

FIG. 4D is a flowchart illustrating a projection method of a projection system according to another embodiment of the invention. Referring to FIG. 4D, a main difference between the projection method of the projection system of the embodiment and the projection method of FIG. 4C is that after the step S312, the step S402 is first executed, and then the step S404 and the step S406 are sequentially executed, i.e. the projection apparatus first provides the situational effect corresponding to the video information according to the video information, and then sequentially executes the steps of performing the environment detection according to the position where the projection apparatus is located, and the step of adjusting the image parameter of the image according to the detection result of the environment detection. Similarly, in the embodiment, the steps S404 and S402 can be simultaneously/sequentially executed after the step S308, or the steps S404 and S402 can be simultaneously/sequentially executed after the step S310.

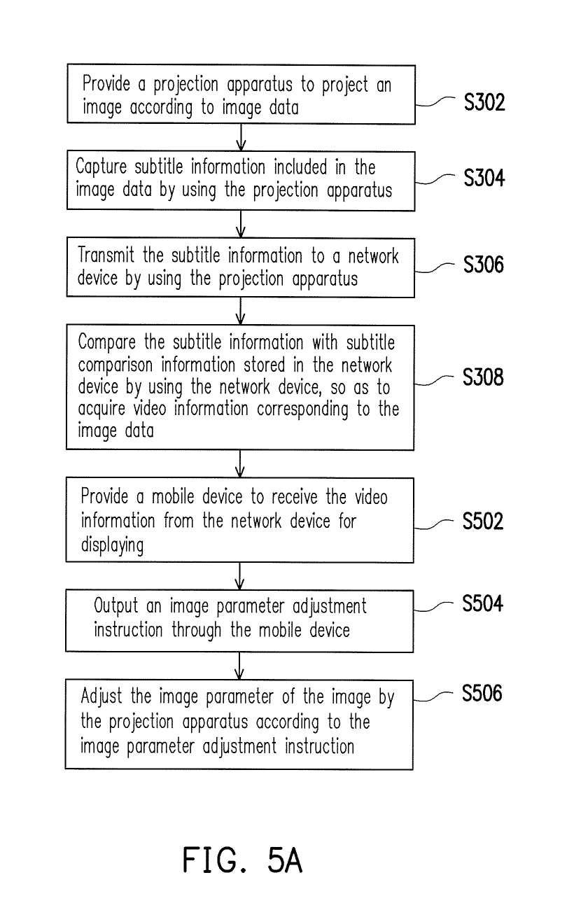

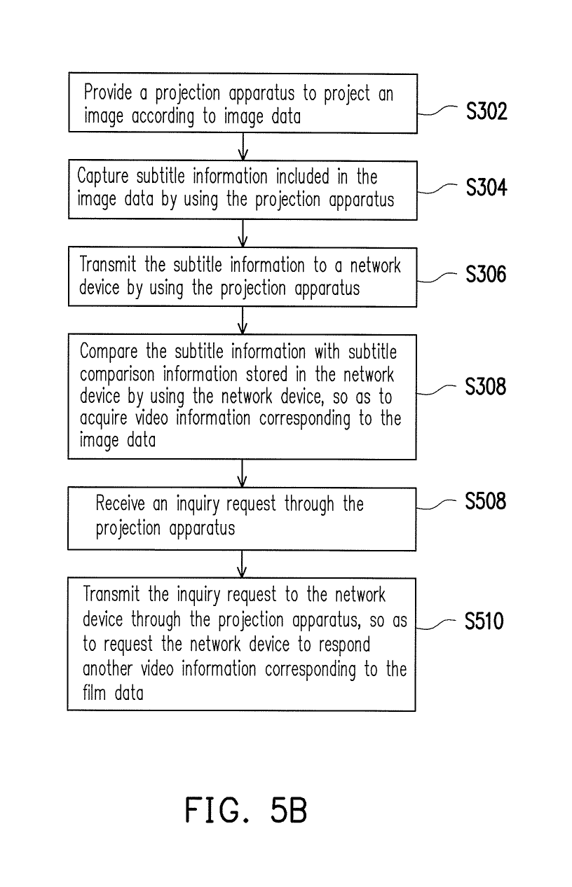

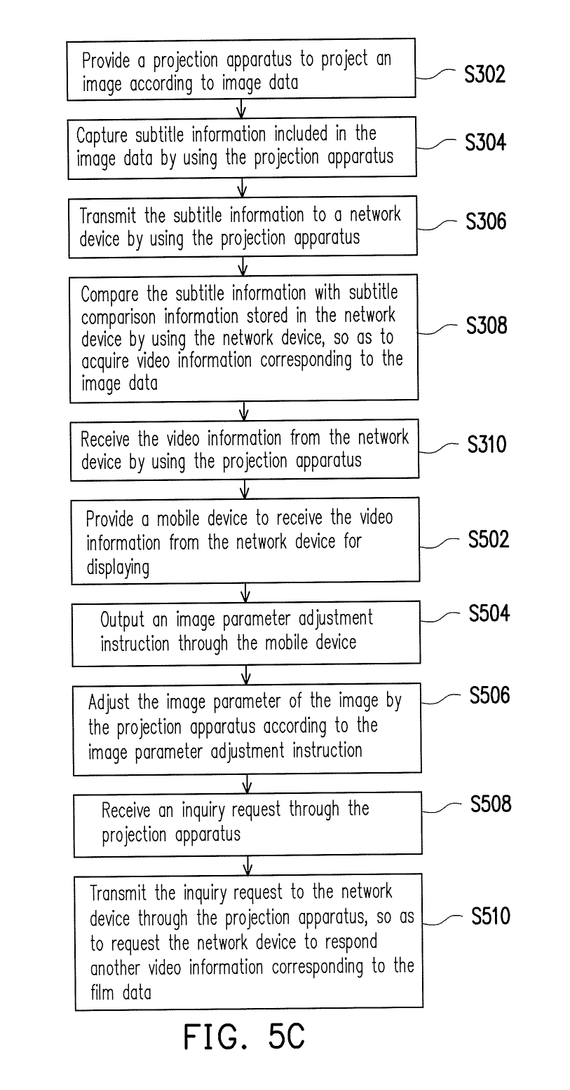

FIG. 5A is a flowchart illustrating a projection method of a projection system according to another embodiment of the invention. Referring to FIG. 5A, a main difference between the projection method of the projection system of the embodiment and the projection method of FIG. 3A is that after the step S308, a mobile device is first provided to receive the video information from the network device for displaying (step S502). Then, an image parameter adjustment instruction is output through the mobile device (step S504). Then, the projection apparatus adjusts the image parameter of the image according to the image parameter adjustment instruction (step S506).

FIG. 5B is a flowchart illustrating a projection method of a projection system according to another embodiment of the invention. Referring to FIG. 5B, a main difference between the projection method of the projection system of the embodiment and the projection method of FIG. 3A is that after the step S308, an inquiry request is first received through the projection apparatus (step S508), for example, an inquiry request operation of the user is received by using the mobile device, and then the inquiry request is transmitted to the network device through the projection apparatus, so as to request the network device to respond/answer another video information corresponding to the video data (step S510).

FIG. 5C is a flowchart illustrating a projection method of a projection system according to another embodiment of the invention. Referring to FIG. 5C, a main difference between the projection method of the projection system of the embodiment and the projection method of FIG. 5A is that the step S310 of FIG. 4D is further executed after the step S308, and the step S508 and the step S510 of FIG. 5B are further executed after the step S506. However, in other embodiments, the step S310 in FIG. 5C can be omitted, i.e. the step S502 is directly executed after the step S308.

In summary, in the invention, the projection apparatus is used for capturing the subtitle information included in the image data. The network device compares the subtitle information with the subtitle comparison information to acquire the video information corresponding to the image data, such that the projection apparatus may actively adjust the parameters of the projected image according to the video information, so as to improve a viewing quality and usage convenience of the projection system. In some embodiments of the invention, the situational signal can be further provided according to the video information, so as to improve a viewing quality. Moreover, the mobile device can be adopted to display related video information, adjust the image parameter and send inquiry request to inquire related information of the video, so as to improve usage convenience of the projection system. In this way, the user may experience an interactive audio-visual enjoyment.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, comprising:
a projection apparatus, adapted to project an image according to image data, and capture subtitle information included in the image data, wherein the projection apparatus comprises:
a projection unit, adapted to project the image;
a control unit, coupled to the projection unit, and adapted to capture the subtitle information; and
a communication unit, coupled to the control unit; and
a network device, adapted to store subtitle comparison information, wherein the communication unit is adapted to communicate with the network device, and the communication unit is controlled by the control unit to transmit the subtitle information to the network device, Wherein the network device is adapted to compare the subtitle information with the subtitle comparison information to acquire video information corresponding to the image data.

2. The projection system as claimed in claim 1, wherein the video information comprises a video type of the image data, the control unit is adapted to receive the video information from the network device through the communication unit, and adjust an image parameter of the image according to the video type of the image data.

3. The projection system as claimed in claim 1, wherein the projection apparatus further comprises:
an optical character recognition unit, coupled to the control unit, and controlled by the control unit to capture and recognize the subtitle information, wherein the communication unit is adapted to transmit the subtitle information to the network device according to a recognition result of the optical character recognition unit.

4. The projection system as claimed in claim 1, further comprising:
a mobile device, adapted to wirelessly connect to the network device, and receive the video information from the network device to display.

5. The projection system as claimed in claim 4, wherein the mobile device is adapted to transmit an image parameter adjustment instruction to the projection apparatus, so as to control the projection apparatus for adjusting the image parameter of the image.

6. The projection system as claimed in claim 1, wherein the projection apparatus further comprises:
a situational playing unit, coupled to the control unit, wherein the control unit is adapted to control the situational playing unit according to the video information, and the situational playing unit is adapted to provide a situational effect corresponding to the video information.

7. The projection system as claimed in claim 1, wherein the projection apparatus further comprises:
a detection unit, coupled to the control unit, and adapted to perform an environment detection according to a position where the projection apparatus is located, wherein the control unit is adapted to adjust an image parameter of the image according to a detection result provided by the detection unit.

8. The projection system as claimed in claim 1, wherein the control unit is adapted to receive an inquiry request through the communication unit, and transmit the inquiry request to the network device through the communication unit, so as to request the network device to respond another video information corresponding to the image data.

9. A projection apparatus, adapted to communicate with a network device, the projection apparatus comprising:
a projection unit, adapted to project an image according to image data;
a control unit, coupled to the projection unit, and adapted to capture subtitle information included in the image data; and
a communication unit, coupled to the control unit, and adapted to communicate with the network device, controlled by the control unit to transmit the subtitle information to the network device, and receive video information acquired by the network device according to the subtitle information.

10. The projection apparatus as claimed in claim 9, wherein the video information comprises a video type of the image data, the control unit is adapted to receive the video information from the network device through the communication unit, and adjust an image parameter of the image according to the video type of the image data.

11. The projection apparatus as claimed in claim 9, further comprising:
an optical character recognition unit, coupled to the control unit, and controlled by the control unit to capture and recognize the subtitle information, wherein the communication unit is adapted to transmit the subtitle information to the network device according to a recognition result of the optical character recognition unit.

12. The projection apparatus as claimed in claim 9, wherein the control unit is adapted to receive an image parameter adjustment instruction from a mobile device through the communication unit, and adjust an image parameter of the image according to the image parameter adjustment instruction, wherein the mobile device is adapted to wirelessly connected to the network device.

13. The projection apparatus as claimed in claim 9, further comprising:
a situational playing unit, coupled to the control unit, wherein the control unit is adapted to control the situational playing unit according to the video information, and the situational playing unit is adapted to provide a situational effect corresponding to the video information.

14. The projection apparatus as claimed in claim 9, further comprising:
a detection unit, coupled to the control unit, and adapted to perform an environment detection according to a position where the projection apparatus is located, wherein the control unit adjusts an image parameter of the image according to a detection result provided by the detection unit.

15. The projection apparatus as claimed in claim 9, wherein the control unit is adapted to receive an inquiry request through the communication unit, and transmit the inquiry request to the network device through the communication unit, so as to request the network device to respond another video information corresponding to the image data.

16. A projection method of a projection system, comprising:
providing a projection apparatus to project an image according to image data;
capturing subtitle information included in the image data by using the projection apparatus;
transmitting the subtitle information to a network device; and
comparing the subtitle information with subtitle comparison information stored in the network device by using the network device, so as to acquire video information corresponding to the image data.

17. The projection method of the projection system as claimed in claim 16, further comprising:
receiving the video information from the network device through the projection apparatus, wherein the video information comprises a video type of the image data; and
adjusting an image parameter of the image by the projection apparatus according to the video type of the image data.

18. The projection method of the projection system as claimed in claim 16, wherein the step of capturing the subtitle information included in the image data comprises:
capturing and recognizing the subtitle information, and transmitting the subtitle information to the network device according to a recognition result.

19. The projection method of the projection system as claimed in claim 16, further comprising:
providing a mobile device to receive the video information from the network device for displaying.

20. The projection method of the projection system as claimed in claim 19, further comprising:
outputting an image parameter adjustment instruction through the mobile device; and
adjusting the image parameter of the image by the projection apparatus according to the image parameter adjustment instruction.

21. The projection method of the projection system as claimed in claim 16, further comprising:
providing a situational effect corresponding to the video information by the projection apparatus according to the video information.

22. The projection method of the projection system as claimed in claim 16, further comprising:
performing an environment detection by the projection apparatus according to a position where the projection apparatus is located; and
adjusting an image parameter of the image by the projection apparatus according to a detection result of the environment detection.

23. The projection method of the projection system as claimed in claim 16, further comprising:
receiving an inquiry request through the projection apparatus; and
transmitting the inquiry request to the network device through the projection apparatus, so as to request the network device to respond another video information corresponding to the image data.
